(19) United States
(12) Patent Application Publication
(10) Pub. No.: US 2018/0023513 A1
(43) Pub. Date: Jan. 25, 2018

(54) ROCKET ENGINE AND IGNITION SYSTEM

(71) Applicant: MITSUBISHI HEAVY INDUSTRIES, LTD., Tokyo (JP)

(72) Inventors: Kimihito OBASE, Tokyo (JP); Yoshihiro KAWAMATA, Tokyo (JP)

(73) Assignee: MITSUBISHI HEAVY INDUSTRIES, LTD., Tokyo (JP)

(21) Appl. No.: 15/547,995

(22) PCT Filed: Feb. 19, 2016
(86) PCT No.: PCT/JP2016/054924

§ 371 Date: Aug. 1, 2017

(30) Foreign Application Priority Data
Feb. 26, 2015 (JP) 2015-036540

(51) Int. Cl. F02K 9/95; F02K 9/52; F02K 9/42

(52) U.S. Cl. CPC F02K 9/95; F02K 9/425; F02K 9/52; F02K 9/605

(57) ABSTRACT

An ignition system (10) includes a fuel injection opening (30), a fuel reforming device (70), an ignition gas injection opening (50) and an ignition gas supply passage (52). The fuel injection opening (30) injects the hydrocarbon fuel into the combustion chamber (20). The fuel reforming device (70) reforms the hydrocarbon fuel to the ignition gas which ignites automatically through contact with the oxidizing agent. The ignition gas injection opening (50) injects the ignition gas into the combustion chamber (20). The ignition gas supply passage (52) supplies the ignition gas to the ignition gas injection opening (50) from the fuel reforming device (70).

### TECHNICAL FIELD

The present invention is relates to a rocket engine and an ignition system.

### BACKGROUND ART

As a fuel ignition device of the rocket engine, an automatic ignition unit (Hypergol Unit) of a cartridge type is known.

As the related techniques, the automatic ignition unit (Hypergol Unit) is shown in FIGS. 2 to 20 on page 45 of Non-Patent Literature 1.

### CITATION LIST

[Non-Patent Literature 1] “Modern Engineering for Design of Liquid Propellant Rocket Engines”, by Dieter K. Huzel et al., U.S.A., AIAA, Jan. 1, 1992

### SUMMARY OF THE INVENTION

An object of the present invention is to provide a rocket engine which is possible to ignite hydrocarbon fuel without preparing special chemical agent, and an ignition system.

A rocket engine in some embodiments include a combustion chamber; a fuel injection opening disposed to inject hydrocarbon fuel into the combustion chamber; an oxidizing agent injection opening disposed to inject oxidizing agent into the combustion chamber; a fuel reforming device disposed to reform the hydrocarbon fuel to ignition gas which ignites automatically through contact with the oxidizing agent; an ignition gas injection opening disposed to inject the ignition gas into the combustion chamber; and an ignition gas supply passage disposed to supply the ignition gas to an ignition gas injection opening from the fuel reforming device.

An ignition system in some embodiments includes an fuel injection opening disposed to inject hydrocarbon fuel into a combustion chamber; a fuel reforming device disposed to reform the hydrocarbon fuel to ignition gas which ignites automatically through contact with oxidizing agent; an ignition gas injection opening disposed to inject the ignition gas into the combustion chamber; and an ignition gas supply passage disposed to supply the ignition gas to the ignition gas injection opening from the fuel reforming device.

According to the present invention, it is possible to provide the rocket engine which can ignite the hydrocarbon fuel without preparing special chemical agent, and the ignition system.

### BRIEF DESCRIPTION OF THE DRAWINGS

The attached drawings are incorporated into this Specification to help the description of embodiments. Note that the drawings should not be interpreted to limit the present invention to illustrated and described examples.

FIG. 1 is a block diagram schematically showing the structure of a rocket engine.

FIG. 2 is a schematic sectional view of an ignition system.

FIG. 3 is a flow chart showing an operation procedure of the ignition system.

FIG. 4 is a block diagram schematically showing the structure of the rocket engine.

FIG. 5 is a schematic perspective view of a combustion chamber and a nozzle in the rocket engine.

FIG. 6 is a sectional view schematically showing a part of the ignition system.

FIG. 7 is a block diagram of a control system of the ignition system.

FIG. 8 is a table showing an example of operation modes of the control system.

FIG. 9A is a sectional view schematically showing a part of the ignition system.

FIG. 9B is a sectional view of the ignition system viewed from the direction of the A-A arrows in FIG. 9A.

FIG. 10A is a schematic perspective view of a part of the ignition system.

FIG. 10B is a schematic sectional view of the part of the ignition system.

FIG. 10C is a sectional view of the ignition system viewed from the direction of the B-B arrows in FIG. 10B.

FIG. 11 is a schematic perspective view of the part of the ignition system.

### DESCRIPTION OF THE EMBODIMENTS

Hereinafter, a rocket engine and an ignition system will be described with reference to the attached drawings. In the following detailed explanation, many detailed specific matters are disclosed for the purpose of the explanation to provide the comprehensive understanding of embodiments. However, it would be apparent that one or plural embodiments are executable without these detailed specific matters.

### (Definition of the Term)

In this Specification, “hypergol ignition” means automatically igniting through contact with oxidizing agent.

### (Matters Recognized by the Inventors)

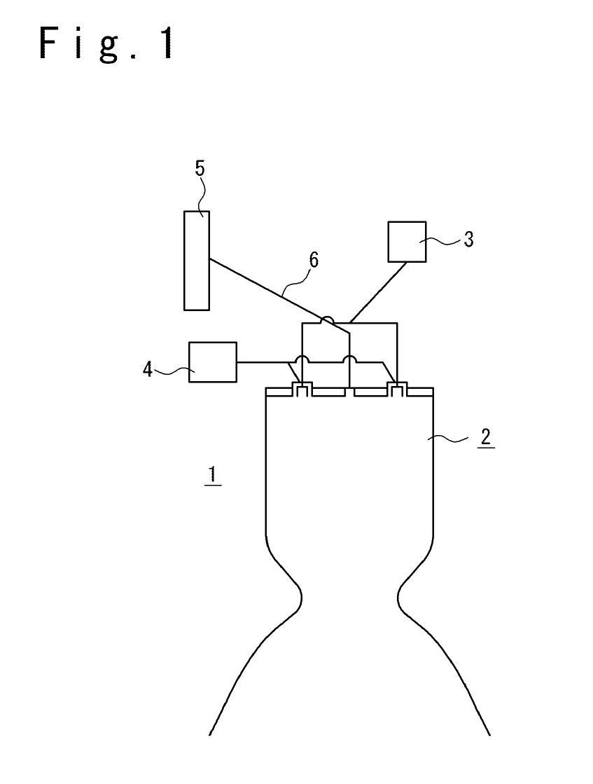

FIG. 1 is a block diagram schematically showing the structure of a rocket engine. The rocket engine 1 includes a combustion chamber 2, a fuel tank 3, an oxidizing agent tank 4, an ignition cartridge 5, and a supply passage 6. In the ignition cartridge 5, hypergol ignition liquid is accommodated that ignites spontaneously when being exposed to or contacting with air at the normal temperature. For example, hypergol ignition liquid is triethylaluminum, triethylborane and so on. The hypergol ignition liquid is supplied to the combustion chamber 2 through the supply passage 6 when a diaphragm of the ignition cartridge 5 is broken. The hypergol ignition liquid supplied to the combustion chamber 2 ignites automatically. By using the flame generated by the hypergol ignition, the fuel supplied from the fuel tank 3 is ignited. The fuel supplied from the fuel tank 3 is combusted by using the oxidizing agent supplied from the oxidizing agent tank 4.

The liquid accommodated in the ignition cartridge 5 is the hypergol ignition liquid that ignites spontaneously at the normal temperature. Therefore, care needs to be taken because hazardous material is handled. Also, basically, the ignition cartridge 5 cannot be used again after using once. Also, when the ignition cartridge 5 is used in case of combustion experiment and so on on the ground, it is necessary to wash the supply passage 6 to remove the hypergol ignition liquid.

The inventors found that the hydrocarbon fuel could be ignited without using the hypergol ignition liquid by using an ignition gas generated through reforming of the hydrocarbon fuel. The hydrocarbon fuel does not ignite spontaneously at the normal temperature. Therefore, the hydrocarbon fuel is easier in treatment than the hypergol ignition liquid.

Note that the rocket engine shown in FIG. 1 is temporarily used to describe the matters recognized by the inventors. Therefore, the rocket engine shown in FIG. 1 is not prior art.

### (Overview of Ignition System)

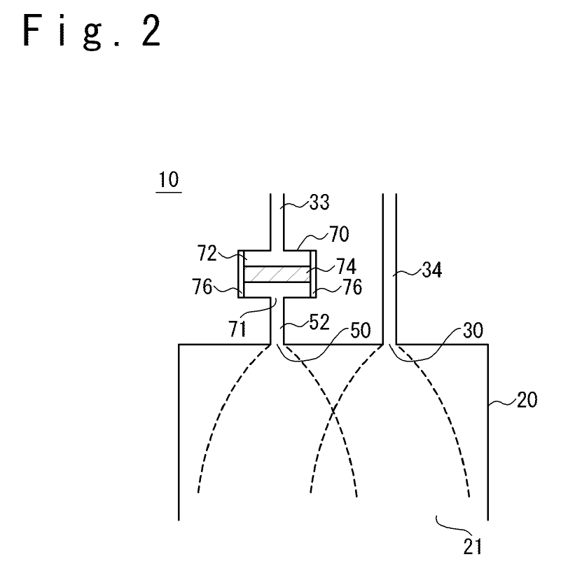

FIG. 2 is a schematic sectional view of the ignition system 10. The ignition system 10 includes the combustion chamber 20, an ignition gas injection opening 50, an ignition gas supply passage 52, a fuel reforming device 70, a first fuel supply passage 33, a fuel injection opening 30, and a second fuel supply passage 34.

The combustion chamber 20 is a combustion chamber to combust hydrocarbon fuel. For example, the combustion chamber 20 is a non-closed type combustion chamber. The combustion gas generated in the combustion chamber 20 is discharged from the combustion chamber 20 through the exit 21 of the combustion chamber 20.

The ignition gas is injected for the internal space of the combustion chamber 20 through the ignition gas injection opening 50. The ignition gas supply passage 52 supplies the ignition gas from the fuel reforming device 70 to the ignition gas injection opening 50. A first end of the ignition gas supply passage 52 is connected with the exit 71 of the fuel reforming device 70. A second end of the ignition gas supply passage 52 is connected with the combustion chamber 20. A connection part of the ignition gas supply passage 52 and the combustion chamber 20 is the ignition gas injection opening 50.

The fuel reforming device 70 reforms the hydrocarbon fuel of liquid to the ignition gas. The hydrocarbon fuel of liquid is hydrocarbon of a large carbon number. The ignition gas is hydrocarbon of a small carbon number or hydrogen. The fuel reforming device 70 includes a fuel reforming chamber 72, a fuel reforming catalyst 74 arranged in the fuel reforming chamber 72, and a heater 76. The hydrocarbon fuel of liquid is supplied to the fuel reforming chamber 72 from the first fuel supply passage 33. The fuel reforming catalyst 74 is catalyst to reform the hydrocarbon fuel of liquid to the ignition gas. The heater 76 activates the fuel reforming catalyst 74 through the heating.

The first fuel supply passage 33 supplies the hydrocarbon fuel of liquid to the fuel reforming device 70.

The hydrocarbon fuel is injected for the internal space of the combustion chamber 20 through the fuel injection opening 30. The second fuel supply passage 34 supplies the fuel to the fuel injection opening 30.

### (Operation Principle of Ignition System)

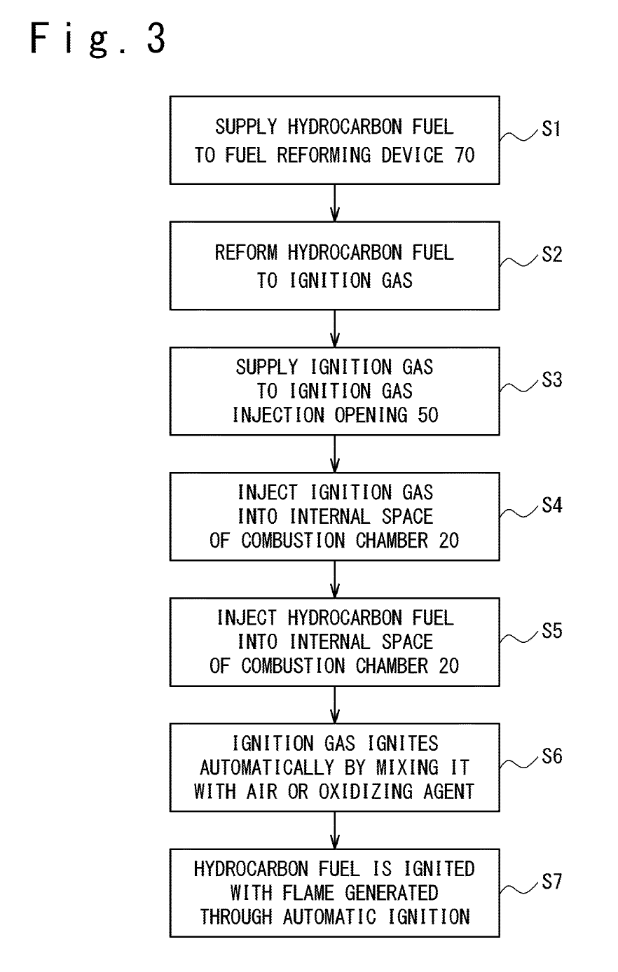

Next, the operation principle of the ignition system 10 will be described. FIG. 3 is a flow chart showing the operation procedure of the ignition system 10.

At first, the hydrocarbon fuel of liquid is supplied to the fuel reforming device 70. The supply of the hydrocarbon fuel is carried out through the first fuel supply passage 33 (first process S1).

At second, the fuel reforming device 70 reforms the hydrocarbon fuel of liquid to the ignition gas. More specifically, the hydrocarbon fuel of liquid and the fuel reforming catalyst 74 are heated in the fuel reforming chamber 72 by using the heater 76. The fuel reforming catalyst 74 activated through the heating pyrolyzes the hydrocarbon fuel of liquid to the ignition gas (the hydrocarbon of a small carbon number or hydrogen). For example, the pyrolysis temperature is several hundred degrees centigrade (second process S2).

At third, the ignition gas generated by the reforming (in other words, by pyrolysis) is supplied to the ignition gas injection opening 50 from the fuel reforming device 70. The supply of the ignition gas is carried out through the ignition gas supply passage 52 which connects the fuel reforming chamber 72 and the combustion chamber 20 (third process S3).

At fourth, the ignition gas is injected for the internal space of the combustion chamber 20 through the ignition gas injection opening 50. The ignition gas is hot (in a high temperature) and hypergol ignition occurs by bringing into contact with the oxidizing agent. The oxidizing agent may be air and may be oxidizing agent other than air (e.g. liquid oxygen and nitrous oxide) (fourth process S4).

At fifth, the hydrocarbon fuel supplied through the second fuel supply passage 34 is injected for the internal space of the combustion chamber 20 through the fuel injection opening (fifth process S5).

At sixth, the ignition gas is mixed with air or the oxidizing agent and then hypergol ignition is caused (sixth process S6).

At seventh, the hydrocarbon fuel injected for the internal space of the combustion chamber 20 is ignited with the flame produced through the hypergol ignition (seventh process S7).

In the embodiment, the hydrocarbon fuel is ignited without using hypergol ignition liquid. Therefore, a treatment risk of the hazardous materials is reduced.

In the embodiment, the ignition of the hydrocarbon fuel is carried out by using the hypergol ignition of the reformed hydrocarbon fuel (i.e. the ignition gas). Therefore, it is not necessary to prepare a spark plug and so on to cause electrical spark.

In the embodiment, when the combustion of hydrocarbon fuel in the combustion chamber 20 is stopped, it is possible to re-ignite the hydrocarbon fuel by restarting the ignition system 10 (in other words, by executing the first process S1 to the seventh process S7 again). In the embodiment, it is easy to carry out re-ignition of the hydrocarbon fuel. Therefore, it is favorable, for example, when a combustion experiment and so on are repeatedly carried out on the ground. Also, it is favorable when the operation of an engine (the combustion of fuel) and the stop of the engine (the stop of the combustion) are repeatedly carried out in the flight.

In the embodiment, it is not necessary to wash the supply passages of the ignition system 10 after the ignition system 10 is used (for example, the ignition gas supply passage 52, the first fuel supply passage 33, the second fuel supply passages 34 etc.). Therefore, the maintenance of the ignition system 10 is easy.

### (More Detailed Description of Ignition System)

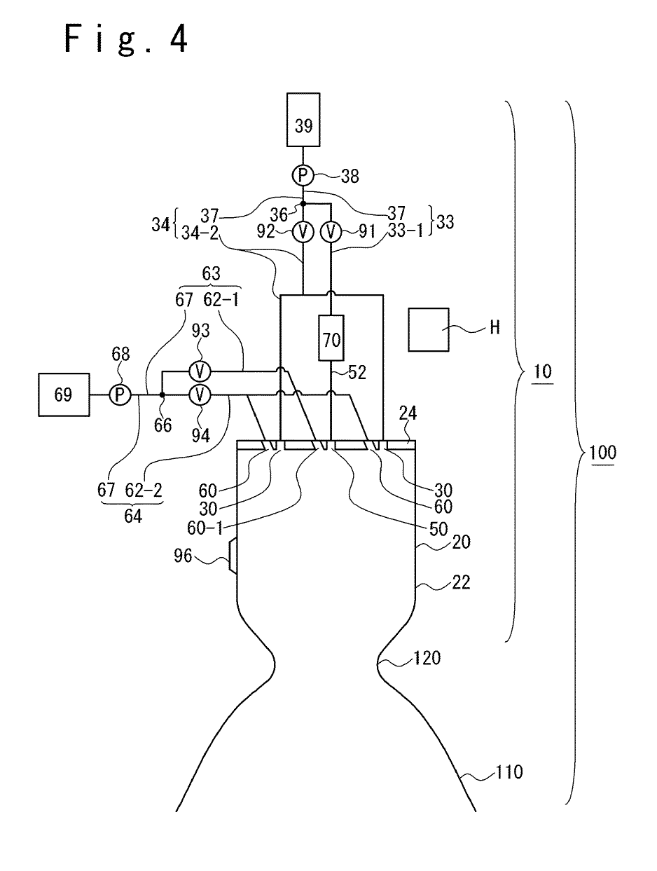

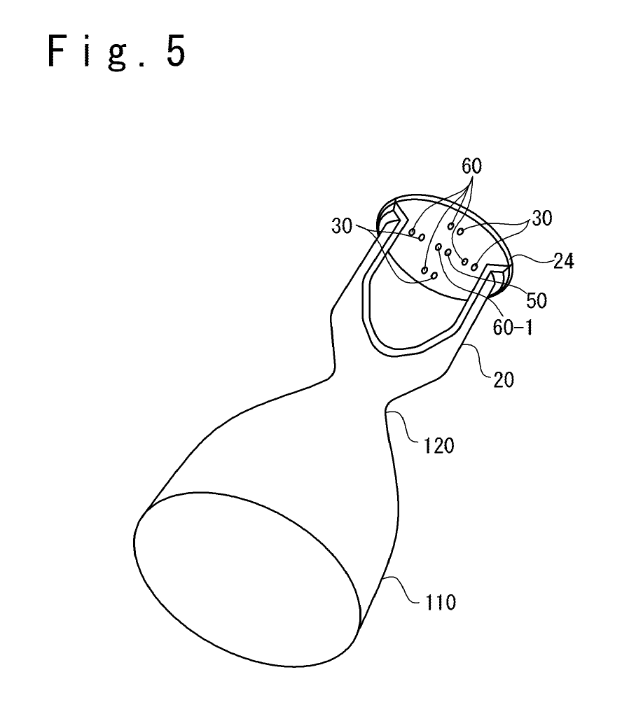

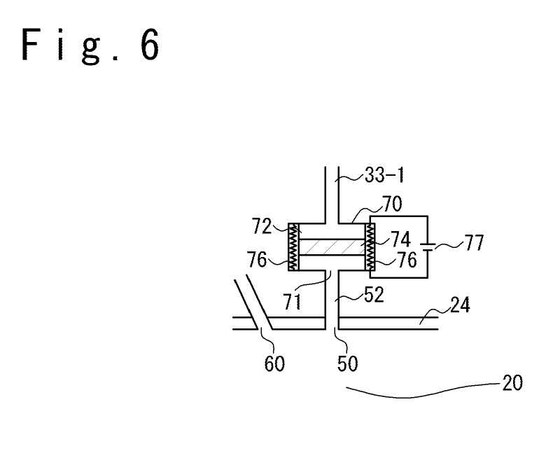

Next, referring to FIG. 4 to FIG. 6, the ignition system 10 will be described in detail. Referring to FIG. 4 to FIG. 6, an example will be described in which the ignition system 10 is applied to the rocket engine 100. FIG. 4 is a schematic block diagram showing the structure of the rocket engine. FIG. 5 is a perspective view of the combustion chamber 20 and a nozzle 110 in the rocket engine 100. In FIG. 5, a part of the wall of the combustion chamber is cut out to show the internal structure of the combustion chamber 20. FIG. 6 is a schematic sectional view of a part of the ignition system 10.

Regarding FIG. 4 to FIG. 6, the same reference numeral is allocated to a member having the same function as the member described with reference to FIG. 2.

The rocket engine 100 includes the ignition system 10, the nozzle 110 and a throat section 120. The combustion chamber 20 of the ignition system 10 is connected with the nozzle 110 through the throat section 120. The nozzle 110 expands the combustion gas generated in the combustion chamber 20 so as to accelerate the combustion gas to a speed of Mach 1 or more. The accelerated combustion gas is ejected from the exit of the nozzle 110 for the rear space of the nozzle. As the reaction to the ejection of the combustion gas to the rear space of the nozzle, the rocket engine 100 acquires a thrust.

The ignition system 10 may include the combustion chamber 20, the fuel injection opening 30, the ignition gas injection opening 50, an oxidizing agent injection opening (60, 60-1), the fuel tank 39, the fuel supply passage (33, 34), the fuel reforming device 70, an ignition gas supply passage 52, an oxidizing agent tank 69, and an oxidizing agent supply passage (63, 64). The ignition system 10 may include a controller H and a sensor 96.

### (Combustion Chamber 20)

The combustion chamber 20 is a chamber prescribed by the side wall 22 and the end wall 24. For example, the side wall 22 is shaped like a cylinder. For example, the end wall 24 is a flat plate shape. The fuel injection opening 30, the oxidizing agent injection opening (60, 60-1) and the ignition gas injection opening 50 are provided in the end wall 24. Note that the fuel injection opening 30 may be provided in the end wall 24 and may be provided in the side wall 22. In the same way, the oxidizing agent injection opening (60, 60-1) may be provided in the end wall 24 and may be provided in the side wall 22. The ignition gas injection opening 50 may be provided in the end wall 24 and may be provided in the side wall 22. The hydrocarbon fuel is supplied to the combustion chamber 20 through the fuel injection opening 30. In the same way, the oxidizing agent is supplied to the combustion chamber 20 through the oxidizing agent injection opening (60, 60-1). The ignition gas is supplied to the combustion chamber 20 through the ignition gas injection opening 50.

### (Fuel Injection Opening 30)

The fuel injection opening 30 injects the hydrocarbon fuel to the internal space of the combustion chamber 20. The number of fuel injection openings is an optional number equal to or more than 1.

### (Ignition Gas Injection Opening 50)

The ignition gas injection opening 50 injects the ignition gas to the internal space of the combustion chamber 20. The number of ignition gas injection openings is equal to or more than one. The ignition gas injection openings 50 may be arranged in the center of the end wall 24 of the combustion chamber 20. By arranging the ignition gas injection openings 50 at the center of the end wall 24, the ignition gas becomes able to be injected for the center part of the combustion chamber 20. Therefore, the ignition gas is most effectively utilized.

### (Oxidizing Agent Injection Opening (60, 60-1))

The oxidizing agent injection opening (60, 60-1) injects the oxidizing agent to the internal space of the combustion chamber 20. The number of oxidizing agent injection openings is an optional number equal to or more than one. Note that the first oxidizing agent injection opening 60-1 is an injection opening to inject the oxidizing agent used for the hypergol ignition of the ignition gas. The other oxidizing agent injection openings 60 are injection openings for injecting the oxidizing agent which is used for the combustion of the hydrocarbon fuel.

### (Fuel Tank 39)

The fuel tank 39 stores the hydrocarbon fuel of liquid (in other words, the hydrocarbon fuel having a large carbon number). The hydrocarbon fuel of liquid are, for example, jet fuel such as Jet A-1, JP-4, JP-5, JP-6, JP-7, and JP-8, and liquid fuel such as dodecene and kerosene having a carbon number of 10 or above to 15 or below or a combination of them.

### (Fuel Supply Passages 33, 34)

The first fuel supply passage 33 supplies the hydrocarbon fuel of liquid from the fuel tank 39 to the fuel reforming device 70. A first end of the first fuel supply passage 33 is connected with the fuel tank 39, and a second end of the first fuel supply passage 33 is connected with the fuel reforming device 70. The first fuel supply passage 33 contains a main supply passage 37 and a first branch route 33-1. The main supply passage 37 is a pipe route arranged between the fuel tank 39 and a branch section 36. A first pump 38 may be arranged in the main supply passage 37 to send the hydrocarbon fuel from the fuel tank 39. The first branch route 33-1 is a pipe route arranged between the branch section 36 and the fuel reforming device 70. A first valve 91 may be arranged in the first branch route 33-1. By opening the first valve 91, the hydrocarbon fuel is supplied to the fuel reforming device 70 from the fuel tank 39. The first valve 91 may be a flow rate control valve.

The second fuel supply passage 34 supplies the hydrocarbon fuel of liquid to the fuel injection openings 30 from the fuel tank 39. The first second end fuel supply passage 34 is connected with the fuel tank 39, and the second ends of the second fuel supply passage 34 are connected with the fuel injection openings 30. The second fuel supply passage 34 contains the main supply passage 37 and a second branch route 34-2. The main supply passage 37 configures a part of the first fuel supply passage 33 and configures a part of the second fuel supply passage 34. In other words, the first fuel supply passage 33 and the second fuel supply passage 34 have a common main supply passage 37. Since the ignition system 10 has the common main supply passage 37, the whole system becomes compact. The second branch route 34-2 is a pipe arranged between the branch section 36 and the fuel injection openings 30. A second valve 92 may be arranged in the second branch route 34-2. By opening the second valve 92, the hydrocarbon fuel is supplied to the fuel injection openings 30 from the fuel tank 39. The second valve 92 may be a flow rate control valve.

The hydrocarbon fuel of liquid is injected from the fuel injection opening 30. Alternatively, by arranging a heater section in the second fuel supply passage 34, the gaseous hydrocarbon fuel may be injected through the fuel injection openings 30. Alternatively, by arranging the fuel reforming device (for example, a device like the above-mentioned fuel reforming device 70) in the second fuel supply passage 34, the reformed hydrocarbon fuel of gas (in other words, the fuel which contains the hydrocarbon fuel of a small carbon number) may be injected through the fuel injection openings 30.

Note that the number and arrangement of pumps (e.g. first pumps 38) are not limited to an example shown in FIG. 4 but are optional. Also, the number and arrangement of valves (e.g. the first valves 91, and the second valves 92) are not limited to examples shown in FIG. 4 but is optional. Moreover, the arrangement of each fuel supply passages is optional, not being limited to the example shown in FIG. 4.

### (Fuel Reforming Device 70)

FIG. 6 is a schematic sectional view of a part of the ignition system which contains the fuel reforming device 70. The fuel reforming device 70 reforms the hydrocarbon fuel of liquid to the ignition gas. The hydrocarbon fuel of liquid is the hydrocarbon of a large carbon number. The ignition gas is hydrocarbon of a small carbon number or hydrogen. The ignition gas is, for example, hydrogen, methane, ethane, ethylene, acetylene, propane, and propylene, and a combination of them.

The fuel reforming device 70 has a fuel reforming chamber 72, a fuel reforming catalyst 74 arranged in the fuel reforming chamber and a heater 76. The hydrocarbon fuel of liquid is supplied to the fuel reforming chamber 72 from the first branch route 33-1 (the first fuel supply passage). The end of the first branch route 33-1 is connected with an input port of the fuel reforming chamber 72. The fuel reforming catalyst 74 is catalyst which reforms the hydrocarbon fuel of liquid to the ignition gas. The fuel reforming catalyst 74 may be held by the wall of the fuel reforming chamber 72 and by a member arranged in the fuel reforming chamber (e.g. a porous member, a mesh member and so on). For example, the fuel reforming catalyst 74 may be a zeolite system catalyst such as H-ZSM-5 catalyst.

The heater 76 activates the fuel reforming catalyst 74 by the heating. For example, the heater 76 is an electric heater. For example, the electric heater converts the electric power supplied from power 77 into the heat by a resistor. By using an electric heater as the heater 76, the fuel reforming device with high reliability can be realized. For example, the heater 76 is arranged on a side wall of the fuel reforming chamber 72. The heater 76 may be embedded in the side wall of the fuel reforming chamber 72.

### (Ignition Gas Supply Passage 52)

The ignition gas supply passage 52 supplies the ignition gas generated by the reforming (in other words, by pyrolysis) to ignition gas injection opening 50 from the fuel reforming chamber 72. The first end of the ignition gas supply passage 52 is connected with the output port 71 of the fuel reforming chamber 72. The second end of the ignition gas supply passage 52 is connected with the ignition gas injection opening 50. Note that a part of the ignition gas passing through the ignition gas supply passage 52 may be liquid (the hydrocarbon of liquid). For example, the temperature of the ignition gas which passes through the ignition gas supply passage 52 is a few hundred degrees centigrade.

The ignition gas that is injected for the internal space of the combustion chamber 20 from the ignition gas injection opening 50 ignite automatically by bringing in contact with the oxidizing agent. The hydrocarbon fuel injected from the fuel injection opening 30 is ignited (fired) by the flame generated through the hypergol ignition.

### (Oxidizing Agent Tank 69)

FIG. 4 shows the oxidizing agent tank 69. The oxidizing agent tank 69 stores the oxidizing agent. For example, the oxidizing agent stored in the oxidizing agent tank 69 is liquid oxygen. When the oxidizing agent stored in the oxidizing agent tank 69 is liquid, the oxidizing agent tank 69 can be made made more compact, compared with a case that the oxidizing agent is gas.

### (Oxidizing Agent Supply Passages 63, 64)

The first oxidizing agent supply passage 63 supplies the oxidizing agent to the first oxidizing agent injection opening 60-1 from the oxidizing agent tank 69. The first end of the first oxidizing agent supply passage 63 is connected with the oxidizing agent tank 69, and the second end of the first oxidizing agent supply passage 63 is connected with the first oxidizing agent injection opening 60-1. The first oxidizing agent injection opening 60-1 is, for example, the oxidizing agent injection opening nearest to the ignition gas injection opening 50 of the plurality of oxidizing agent injection openings. When the ignition gas contacts the oxidizing agent injected from the first oxidizing agent injection opening 60-1, the ignition gas ignites automatically. The oxidizing agent may be injected in the condition of liquid or gas. The first oxidizing agent supply passage 63 contains a main supply passage 67 and a first branch route 62-1. The main supply passage 67 is a pipe arranged between the oxidizing agent tank 69 and a branch section 66. A second pump 68 may be arranged in the main supply passage 67 to send the oxidizing agent from the oxidizing agent tank 69. The first branch route 62-1 is a pipe arranged between the branch section 66 and the first oxidizing agent injection opening 60-1. A third valve 93 may be arranged in the first branch route 62-1. By opening the third valve 93, the oxidizing agent is supplied to the first oxidizing agent injection opening 60-1 from the oxidizing agent tank 69. The third valve 93 may be a flow rate control valve.

The second oxidizing agent supply passage 64 supplies the oxidizing agent to the oxidizing agent injection openings 60 except for the first oxidizing agent injection opening 60-1 from the oxidizing agent tank 69. The first end of the second oxidizing agent supply passage 64 is connected with the oxidizing agent tank 69. The second end of the second oxidizing agent supply passage 64 is connected with the oxidizing agent injection openings 60. The second oxidizing agent supply passage 64 contains the main supply passage 67 and a second branch route 62-2. The main supply passage 67 configures a part of the first oxidizing agent supply passage 63 and configures a part of the second oxidizing agent supply passage 64. In other words, the first oxidizing agent supply passage 63 and the second oxidizing agent supply passage 64 has the main supply passage 67 in common. Since the ignition system 10 has the common main supply passage 67, the whole system becomes compact. The second branch route 62-2 is a pipe arranged between the branch section 66 and the oxidizing agent injection openings 60. A fourth valve 94 may be arranged in the second branch route 62-2. By opening the fourth valve 94, the oxidizing agent is supplied to the oxidizing agent injection openings 60 from the oxidizing agent tank 69. The fourth valve 94 may be a flow rate control valve.

The oxidizing agent is injected from the first oxidizing agent injection opening 60-1. The oxidizing agent injected through the first oxidizing agent injection opening 60-1 is brought into contact with the ignition gas. The ignition gas ignites automatically through contact with the oxidizing agent.

The oxidizing agent is injected through the oxidizing agent injection openings 60. The oxidizing agent injected through the oxidizing agent injection openings 60 is mixed with the hydrocarbon fuel injected from the fuel injection openings 30. The hydrocarbon fuel mixed with the oxidizing agent is combusted in the combustion chamber 20.

Note that the number and arrangement of pumps (e.g. the second pumps 68) are not limited to an example shown in FIG. 4 but is optional. Also, the number and arrangement of the valves (e.g. third valves 93, the fourth valves 94) are not limited to an example shown in FIG. 4 but is optional. Moreover, the arrangement of each oxidizing agent supply passage is also optional, not being limited to an example shown in FIG. 4.

(Controller H) The controller H transmits control command signals to control target devices such as the first pump 38, the first valve 91, the second valve 92, the second pump 68, the third valve 93, the fourth valve 94, to control the control target devices. The controller contains a hardware processor.

### (Sensor 96)

The sensor 96 is a sensor which measures a state quantity of the combustion chamber. The sensor 96 may be a pressure sensor or may be a temperature sensor. The sensor 96 transmits to the controller H, a signal corresponding to the state of the combustion chamber (for example, the state that combustion is normally carried out, or the state that combustion is not carried out, and so on).

The functions of the controller H and the sensor 96 will be described later.

In an example shown in FIG. 4 to FIG. 6, the fuel tank 39 is a fuel supply source to the fuel injection opening and a supply source of the hydrocarbon fuel to generate the ignition gas. The whole system can be made compact by communalizing a part of the configuration for supplying hydrocarbon fuel to the combustion chamber and a part of the configuration for the ignition.

### (Control of Ignition System 10)

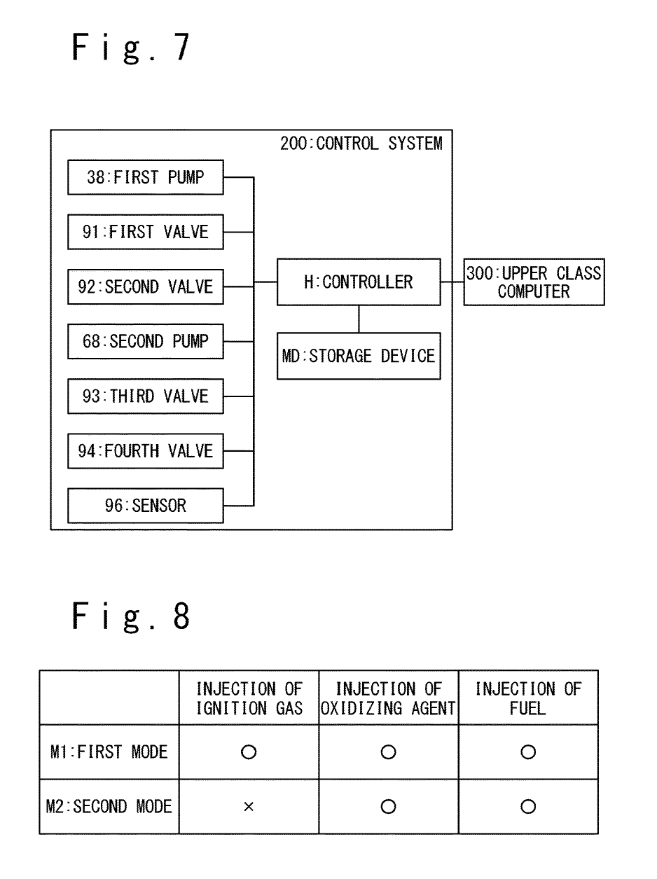

Next, referring to FIG. 7 and FIG. 8, an example of control of the ignition system 10 will be described. FIG. 7 is a block diagram showing the control system 200 of the ignition system 10. FIG. 8 is a table showing an example of the operation modes of the the control system 200.

The control system 200 contains a storage device MD, the controller H, the sensor 96 and a control target apparatus. For example, the control target apparatus is a first pump 38, a first valve 91, a second valve 92, a second pump 68, a third valve 93, a fourth valve 94 and so on.

A storage device MD is connected with the controller H to be communicable. A program to be executed by the hardware processor of the controller H and so on is stored in the storage device MD. The program includes a program to realize a first mode M1 to be described later and a program to realize a second mode M2 to be described later.

The sensor 96 is connected with the controller H to be communicable. The sensor 96 measures a state quantity in the combustion chamber (a pressure, a temperature and so on) and transmits a signal corresponding to the measurement result to the controller H.

The controller H and each control target apparatus are connected to each other to be communicable. The controller H transmits a control command signal to each control target apparatus based on a command signal from a host computer 300 or a signal from the sensor 96. Each control target apparatus operates based on the control command signal.

For example, when the operation command signal is transmitted to the first pump 38 from the controller H, the first pump 38 operates to send the hydrocarbon fuel in the fuel tank 39 to the main supply passage 37. When an opening command signal is transmitted to the first valve 91 from the controller H, the first valve 91 is opened such that the hydrocarbon fuel in the main supply passage 37 is sent to the fuel reforming device 70.

FIG. 8 is a table showing an example of operation modes of the control system 200.

The controller H executes a first mode M1 so that the injection of the ignition gas into the combustion chamber 20, the injection of the oxidizing agent into the combustion chamber 20, and the injection of the hydrocarbon fuel into the combustion chamber 20 are carried out. The injection of the ignition gas, the injection of the oxidizing agent and the injection of the hydrocarbon fuel may be carried out at a same time. Note that the injection of the oxidizing agent is carried out from the first oxidizing agent injection opening 60-1 at least. The injection of the oxidizing agent from another oxidizing agent injection opening 60 may be carried out and may not be carried out.

In the execution of the first mode M1, for example, an operation command signal is sent from the controller H to the first pump 38. An opening command signal is sent to the first valve 91 and the second valve 92 from the controller H. An operation command signal is sent from the controller H to the second pump 68. An opening command signal is sent to the third valve 93 and the fourth valve 94 from the controller H.

The controller H executes the first mode M1 so that the ignition gas, the oxidizing agent and the hydrocarbon fuel are injected in the combustion chamber 20. Through a contact between the ignition gas and the oxidizing agent, the ignition gas is spontaneously ignited. Also, a flame generated with the hypergol ignition reaches the hydrocarbon fuel and ignites the hydrocarbon fuel (the ignition of the hydrocarbon fuel). It is possible to say that the first mode M1 is an ignition mode.

The controller H executes a second mode M2 so that the injection of the oxidizing agent into the combustion chamber 20 and the injection of the hydrocarbon fuel into the combustion chamber 20 are carried out at a same time. Note that the injection of the oxidizing agent is carried out from the oxidizing agent injection openings 60 except for the first oxidizing agent injection opening 60-1 at least. The injection of the oxidizing agent from the first oxidizing agent injection opening 60-1 may be carried out and may not be carried out. In the second mode M2, the injection of the ignition gas from the ignition gas injection opening 50 has been stopped.

In the execution of the second mode M2, for example, an operation command signal is sent from the controller H to the first pump 38. A closure command signal is sent from the controller H to the first valve 91. The opening command signal is sent from the controller H to the second valve 92. An operation command signal is sent from the controller H to the second pump 68. A closure command signal is sent from the controller H to the third valve 93. An opening command signal is sent from the controller H to the fourth valve 94.

The controller H executes the second mode M2 so that the injection of the hydrocarbon fuel and the oxidizing agent is carried out for a flame in the combustion chamber 20. By executing the second mode M2, the combustion of the hydrocarbon fuel is intermittently carried out. It is possible to say that the second mode M2 is a steady combustion mode.

The execution of the first mode M1 may be carried out based on the command signal from the host computer 300. That is, the controller H executes the first mode M1 based on an ignition command signal from the host computer 300, so that the ignition of the hydrocarbon fuel is carried out.

The execution of the first mode M1 may be carried out based on the signal from the sensor 96. For example, it is assumed that the combustion of the hydrocarbon fuel is stopped due to any disturbance during the execution of the second mode M2. The stop of the combustion of the hydrocarbon fuel can be detected through the detection of the decline of the pressure or the decline of the temperature by the sensor 96. When the controller H determines based on the signal from the sensor 96 that the combustion of the hydrocarbon fuel is stopped, the first mode M1 is executed. Re-ignition to the hydrocarbon fuel is carried out by the execution of the first mode M1.

The execution of the second mode M2 may be carried out based on the command signal from the host computer 300. For example, the host computer 300 may transmit a start command signal to the controller H after a predetermined time elapse from issuance of the ignition command signal, to start the second mode. In this case, after the predetermined time elapses, the transition from the ignition mode to the steady combustion mode is carried out.

The execution of the second mode M2 may be carried out based on the signal from the sensor 96. It is possible to detect whether the ignition of the hydrocarbon fuel has completed, by the sensor 96. For example, the ignition completion to the hydrocarbon fuel can be detected through the detection of the rise of the pressure or the rise of the temperature by the sensor 96. When the controller H determines that the ignition to the hydrocarbon fuel has completed, based on the signal from the sensor 96, the second mode M2 is executed. In this case, after the ignition completion to the hydrocarbon fuel, the transition to the steady combustion mode is carried out.

In an example shown in FIG. 7 and FIG. 8, it is possible to smoothly carry out the transition to the steady combustion mode from the ignition mode or to the ignition mode (the re-ignition mode) from the steady combustion mode, by preparing the controller H which can execute the first mode M1 and the second mode M2.

### MODIFICATION EXAMPLE 1

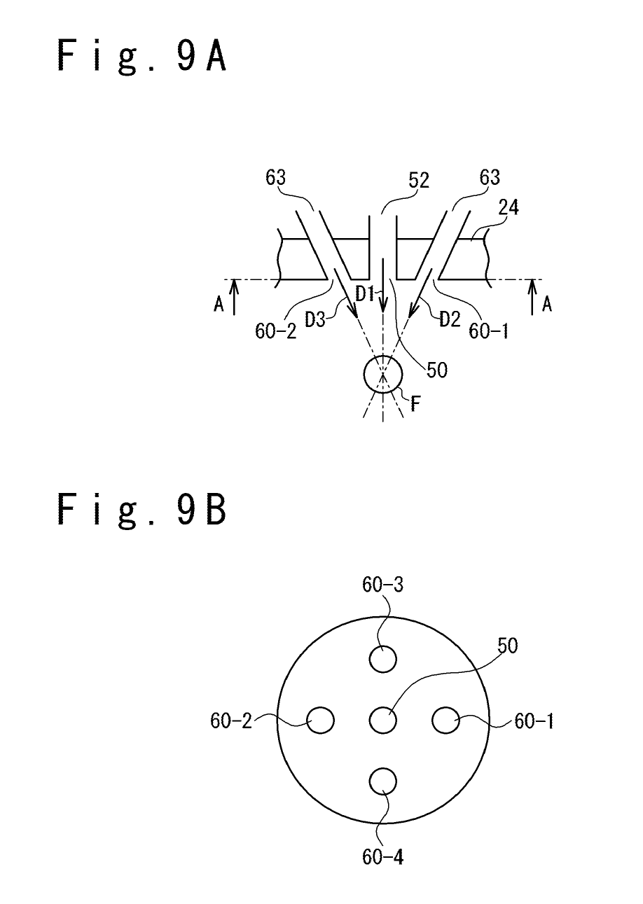

FIG. 9A and FIG. 9B show a modification example of the ignition gas injection openings and the first oxidizing agent injection opening. FIG. 9A is a schematic sectional view of a part of ignition system 10. FIG. 9B is a section view of the ignition system 10 viewed from the A-A arrow in FIG. 9A.

In an example shown in FIG. 9A and FIG. 9B, the injection direction D1 of the ignition gas from the ignition gas injection opening 50 is a direction which intersects with the injection direction D2 of the oxidizing agent from the first oxidizing agent injection opening 60-1. Since the injection direction D1 and the injection direction D2 intersect with each other, the contact between the ignition gas and the oxidizing agent becomes sure. Also, a region of high concentration of the ignition gas and a region of high concentration of the oxidizing agent are generated in a region F where the injection direction D1 and the injection direction D2 intersect with each other, so that the hypergol ignition of the ignition gas becomes surer.

Also, in an example shown in FIG. 9A and FIG. 9B, the oxidizing agent injection opening 60-1 and the oxidizing agent injection opening 60-2 are arranged symmetrically with respect to ignition gas injection opening 50. Therefore, it becomes possible to stably generate the region F of the high concentration of the oxidizing agent to the injection direction of the ignition gas by injecting the oxidizing agent from the oxidizing agent injection opening 60-1 and the oxidizing agent injection opening 60-2 at the same time.

Moreover, in an example shown in FIG. 9A and FIG. 9B, an oxidizing agent injection opening 60-3 and an oxidizing agent injection opening 60-4 are arranged symmetrically with respect to the ignition gas injection opening 50. Moreover, the arrangement of each injection opening (the ignition gas injection opening 50, and the plurality of first oxidizing agent injection openings 60-1 to 60-4) and the direction of each supply passage (the ignition gas supply passage 52 and the plurality of oxidizing agent supply passages 63) are set such that the injection direction D1 of the ignition gas from the ignition gas injection opening 50 and the injection direction of each oxidizing agent injection opening (the injection direction D2 of the oxidizing agent from the oxidizing agent injection opening 60-1, the injection direction D3 of the oxidizing agent from the oxidizing agent injection opening 60-2, the injection direction of the oxidizing agent from the oxidizing agent injection opening 60-3, and the injection direction of the oxidizing agent from the oxidizing agent injection opening 60-4) cross at one point. Therefore, the region of high concentration of the ignition gas and the region of the high concentration of the oxidizing agent are formed in the neighbor region F to the point where the injection direction D1 of the ignition gas and the injection direction from each oxidizing agent injection opening intersect to each other. As a result, the hypergol ignition of the ignition gas becomes surer.

### MODIFICATION EXAMPLE 2

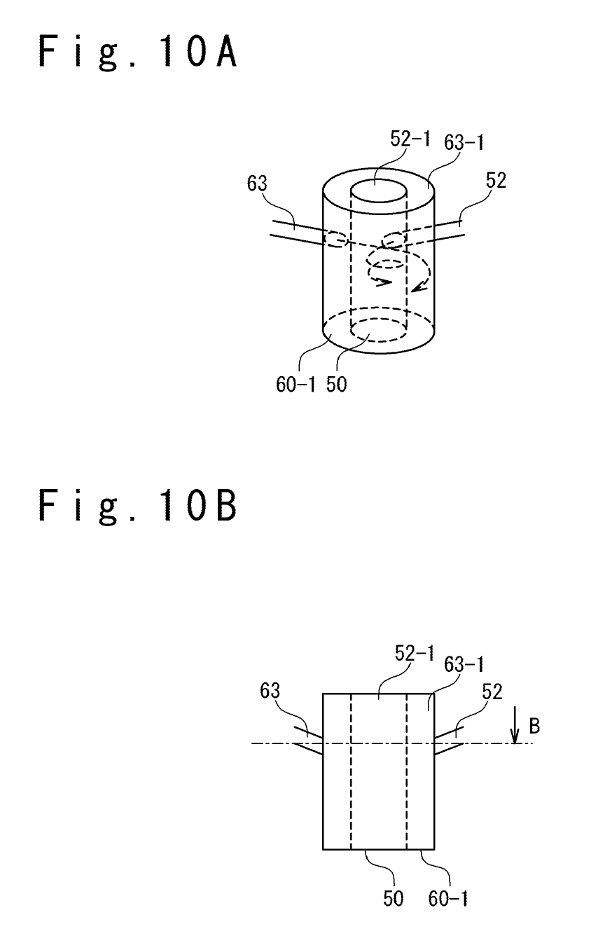

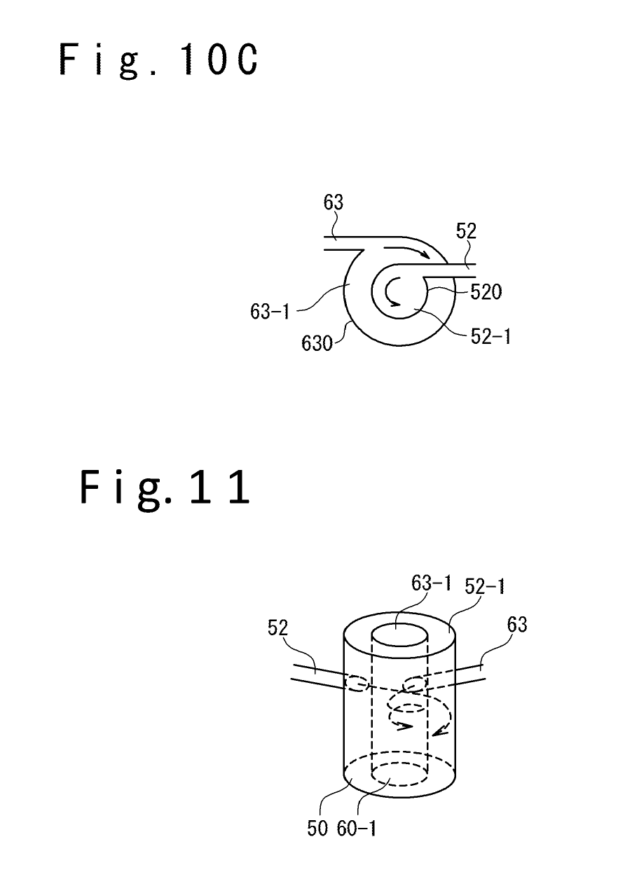

FIG. 10A to FIG. 10C show a modification example of the first oxidizing agent injection opening and the ignition gas injection opening. FIG. 10A is a schematic perspective view of a part of ignition system 10. FIG. 10B is a schematic sectional view of the part of ignition system 10. FIG. 10C is a sectional view of the ignition system 10 viewed from the B-B arrow of FIG. 10B.

In an example shown in the FIG. 10A to FIG. 10C, a tip part 52-1 of the ignition gas supply passage 52 and a tip part 63-1 of the oxidizing agent supply passage 63 configure a double pipe structure. In the example shown in FIG. 10A to FIG. 10C, the inner pipe of the double pipe structure is the tip part 52-1 of the ignition gas supply passage, and the outer pipe of the double pipe structure is a tip part 63-1 of the oxidizing agent supply passage.

When the tip part 52-1 of the ignition gas supply passage and the tip part 63-1 of the oxidizing agent supply passage configure the double pipe structure, it becomes possible to make the ignition gas injection opening 50 and the first oxidizing agent injection opening 60-1 approach. Therefore, the contact between the ignition gas and the oxidizing agent becomes surer, and the hypergol ignition of the ignition gas becomes surer.

Also, the tip part 52-1 of the ignition gas supply passage has a first swirling flow generating section. The first swirling flow generating section is formed by connecting the ignition gas supply passage 52 in the tangent direction of a circle 520 which is the section of the inner pipe in the double pipe cross section (referring to FIG. 10C). Note that the first swirling flow generating section can be configured from a vane arranged in the inner pipe. The technique of generating the swirling flow by use of the vane is a generally known technique.

A tip part 63-1 of the oxidizing agent supply passage has a second swirling flow generating section. The second swirling flow generating section is formed by connecting the oxidizing agent supply passage 63 in a tangent direction of the circle 630 which is the section of an outer pipe in the double pipe cross section (referring to FIG. 10C). Note that the second swirling flow generating section can be configured from a vane which is arranged in the outer pipe. The technique of generating a swirling flow by use of the vanes is generally a known technique.

The swirling direction of the ignition gas which is formed by the first swirling flow generating section and the the swirling direction of the oxidizing agent which is formed by the second swirling flow generating section may be a same direction or may be an opposition direction. Note that it is desirable that the swirling direction of the ignition gas which is formed by the first swirling flow generating section and the swirling direction of the oxidizing agent which is formed by the second swirling flow generating section are identical to each other. The swirling directions of both are identical, and the ignition gas and the oxidizing agent are supplied so that a difference is generated between the momentum (or the rotation speed) of the ignition gas and the momentum (or the rotation speed) of the oxidizing agent, to promote the combustion of the ignition gas.

In an example shown in FIG. 10A to FIG. 10C, the ignition gas which is injected from the ignition gas injection opening 50 forms the first swirling flow and the oxidizing agent which is injected from the first oxidizing agent injection opening 60-1 forms the second swirling flow around the first swirling flow. The mixing of ignition gas and oxidizing agent is promoted due to the speed difference or momentum difference of the circumferential direction between the first swirling flow of the ignition gas which is inside and the second swirling flow of the oxidizing agent which is outside. As a result, the hypergol ignition of the ignition gas becomes surer.

Note that the hypergol ignition of the ignition gas is surer in the example shown in FIG. 10A to FIG. 10C than in the example shown in FIG. 9A and FIG. 9B, because the contact area between the ignition gas and the oxidizing agent is large. On the other hand, the manufacture is easier in the example shown in FIG. 9A and FIG. 9B than in the example shown in the FIG. 10A to FIG. 10C because the configuration of the ignition gas injection opening 50, the ignition gas supply passage 52, the first oxidizing agent injection opening 60-1, and the oxidizing agent supply passage 63 are simple.

### MODIFICATION EXAMPLE 3

A modification example of the ignition gas injection opening and the first oxidizing agent injection opening is shown in FIG. 11. FIG. 11 is a perspective view of a part of the ignition system 10.

As shown in FIG. 11, the inner pipe of the double pipe structure may be the tip part 63-1 of the oxidizing agent supply passage, and the outer pipe of the double pipe structure may be the tip part 52-1 of the ignition gas supply passage.

Note that the ignition system according to the present embodiment can be applied to an engine except for the rocket engine. Also, the ignition system according to the present embodiment can be applied to an apparatus except for the engine.

The present invention is not limited to each of the above embodiments. It would be apparent that each embodiment may be changed or modified appropriately in the range of the technical thought of the present invention. Also, various techniques used in each embodiment or the modification example can be applied to the other embodiment or the modification example unless the technical contradiction occurs.

This application is based on Japan Patent application No. 2015-36540 filed on Feb. 26, 2015, and claims a priority based on the application. The disclosure thereof is incorporated herein by reference.

1. A rocket engine comprising:
a combustion chamber;
a fuel injection opening disposed to inject hydrocarbon fuel into the combustion chamber;
an oxidizing agent injection opening disposed to inject oxidizing agent into the combustion chamber;
a fuel reforming device disposed to reform the hydrocarbon fuel to ignition gas which ignites automatically through contact with the oxidizing agent;
an ignition gas injection opening disposed to inject the ignition gas into the combustion chamber; and
an ignition gas supply passage disposed to supply the ignition gas to the ignition gas injection opening from the fuel reforming device.

2. The rocket engine according to claim 1, wherein the fuel reforming device comprises:
a fuel reforming chamber disposed to house fuel reforming catalyst to reform the hydrocarbon fuel to the ignition gas; and
a heater disposed to heat the fuel reforming catalyst.

3. The rocket engine according to claim 2, wherein the heater comprises an electric heater.

4. The rocket engine according to claim 1, wherein the oxidizing agent is liquid oxygen.

5. The rocket engine according to claim 1, further comprising:
a fuel tank disposed to store the hydrocarbon fuel;
a first fuel supply passage disposed to supply the hydrocarbon fuel to the fuel reforming device from the fuel tank; and
a second fuel supply passage disposed to supply the hydrocarbon fuel to the fuel injection opening from the fuel tank.

6. The rocket engine according to claim 5, wherein the first fuel supply passage comprises:
a main supply passage arranged between the fuel tank and a branch section; and
a first branch route arranged between the branch section and the fuel reforming device, and
wherein the second fuel supply passage comprises:
a second branch route arranged among the main supply passage, the branch section and the fuel injection opening.

7. The rocket engine according to claim 1, further comprising a double pipe structure,
wherein one of an inner pipe and an outer pipe of the double pipe structure is a part of the oxidizing agent supply passage disposed to supply the oxidizing agent to the oxidizing agent injection opening, and
wherein the other of the inner pipe and the outer pipe of the double pipe structure is a part of the ignition gas supply passage.

8. The rocket engine according to claim 7, wherein the ignition gas supply passage comprises a first swirling flow generating section disposed to generate a swirling flow of the ignition gas, and
wherein the oxidizing agent supply passage comprises a second swirling flow generating section disposed to generate a swirling flow of the oxidizing agent.

9. The rocket engine according to claim 1, wherein an injection direction of the oxidizing agent from the oxidizing agent injection opening intersects an injection direction of the ignition gas from the ignition gas injection opening.

10. The rocket engine according to claim 1, further comprising a controller,
wherein the controller selectively executes:
a first mode in which the injection of the ignition gas into the combustion chamber, the injection of the oxidizing agent into the combustion chamber, and the injection of the hydrocarbon fuel into the combustion chamber are carried out; and
a second mode in which the injection of the ignition gas into the combustion chamber is stopped and the injection of the oxidizing agent into the combustion chamber and the injection of the hydrocarbon fuel into the combustion chamber are carried out.

11. An ignition system comprising:
a fuel injection opening disposed to inject hydrocarbon fuel into a combustion chamber;
a fuel reforming device disposed to reform the hydrocarbon fuel to ignition gas which ignites automatically through contact with the oxidizing agent;
an ignition gas injection opening disposed to inject the ignition gas into the combustion chamber; and
an ignition gas supply passage disposed to supply the ignition gas to the ignition gas injection opening from the fuel reforming device.
